(19) United States
(12) Patent Application Publication
(10) Pub. No.: US 2005/0120614 A1
(43) Pub. Date: Jun. 9, 2005

(54) Bottom fish rig

(76) Inventor: Frank T. Brzozowski, Philadelphia, PA (US)

Correspondence Address: ANTHONY EDW. J CAMPBELL, PO BOX 160370, AUSTIN, TX, 78716, US

(21) Appl. No.: 10/731,668

(22) Filed: Dec. 9, 2003

(51) Int. Cl. A01K 91/14; A01K 91/00

(52) U.S. Cl. 43/43.15

(57) ABSTRACT

A bottom fish rig for catching bottom feeding fish has an elongated leader having a hook end and a line end. The hook end having a hook eye loop and the line end having a line eye loop. A first movement stop is frictionally connected to the leader. A second movement stop is frictionally connected to the leader. The second movement stop is located between the first movement stop and the leader hook end. A c-weight is slidably connected to the leader. The c-weight has a first end having a first bore and a second end having a second bore.

### BACKGROUND OF THE INVENTION

1. Field of the Invention

The present embodiment of the invention relates to a bottom fish rig for use in connection with fishing tackle. The bottom fish rig has particular utility in connection with fishing tackle having a slidable weight with a sliding three pronged hook.

2. Description of the Prior Art

Bottom fish rigs are desirable for fishing Carp and other bottom dwelling fish. Carp and other bottom feeding fish typically tap bait with their nose several times before picking it up. If the fish feels tension in the line when it bumps the bait, it may not strike. The following invention allows the fish to tap the bait and have the bait freely move on the leader until the leader end when the hook is set.

The use of fishing tackle is known in the prior art. For example, U.S. Pat. No. 4,914,852 to Hnizdor discloses A tandem double offset fishhook includes first and second hooks, each having a shank, an offset bend curving concavely from one end of the shank and a point at the end of the bend. The shank of one of the first and second hooks is longer than the other shank with respect to the eye formed at one end of one of the shanks so as to space the points of the first and second shanks apart. The offset bends of the first and second hooks are disposed at equal inverted angles on opposite sides of a vertical plane through the first and second shanks to generate forces which cause the fishhook to rotate and spin as it is drawn through the water while being reeled in. In one embodiment, the first and second shanks are integrally formed from a single elongated wire, with the eye disposed between the ends of the shank at one end and the shanks being disposed side-by-side in parallel. In another embodiment, the shank of one hook is rigidly connected to the shank of the other hook adjacent the bend of the other hook to form a co-linear extension of the other hook. However, the Hnizdor '852 patent does not have a slidable weight and a slidable treble hook both having movement stops.

Similarly, U.S. Pat. No. 2,703,947 to Petrasek discloses a fish lure comprising a concavo-convex spoon member with slightly upwardly curved sides. The spoon member being substantially tear-drop shaped in outline and having a substantially rounded front end and an elongated tail end. The spoon member having an elongated depression formed therein and located centrally and symmetrically to the longitudinal axis thereof. A readily removable elongated weight member is located within the depression. A first screw connects the weight member to the spoon. A hook member comprises a shank extending in a continuation of the longitudinal axis and has an end extending through an opening formed in the tail end. At least one hook upon the other end of the shank and another screw connects the first mentioned end of the shank to the spoon. The first screw associates the spoon member with weights having different masses. However, the Petrasek '947 patent does not have a slidable weight and a slidable treble hook both having movement stops.

Additionally, U.S. Pat. No. 5,022,178 to Carlson discloses a fishing rig for live or artificial bait has a bendable member mounted between at least two hooks, particularly treble hooks, the hooks being mounted with respect to a leader such that when one hook is set in a fish, the bendable member bends upon a pull of the leader and the other hook moves toward the set hook. The bending of the bendable member forces the other hook into a set condition and enlarges the transverse width of the rig within the fish so that a double hooking action is guaranteed. However, the Carlson '178 patent does not have a slidable weight and a slidable treble hook both having movement stops.

Further, U.S. Pat. No. 4,888,910 to Lewis discloses an adjustable snelled hook assembly comprises a fishing line with a trailing hook secured thereto. An auxiliary hook has a shank, a barb and an eye loosely and slidably mounted upon the fishing line adjustably spaced from the trailing hook. A coil spring is mounted upon the shank and is generally parallel to the fishing line. A plurality of continuous windings of the line extend around and snugly engage the spring and shank to anchor the auxiliary hook upon the fishing line. However, the Lewis '910 patent does not have a slidable weight and a slidable treble hook both having movement stops.

Yet further, U.S. Pat. No. 5,673,508 to Snyder discloses a beaded fishing lure having a weighted body molded to a fish hook and including a beaded trailer hook. A flapper piece oscillates with lure movement about a projecting extension of the hook shank to strike the body and produce audible sound. The flapper is secured to the body with a split ring at aligned apertures and from a slot which mounts about the hook extension. The eye of the trailer hook is secured to the shank of the primary hook and a bead is molded to the trailer hook. A variety of dressings mount to the bead including multi-filament skirts and molded plastic tails. However, the Snyder '508 patent does not have a slidable weight and a slidable treble hook both having movement stops.

Lastly, U.S. Pat. No. 5,386,660 to Levin discloses A fishing hook with curved barb that is resistant to accidental dislodgement from the mouth of a fish, yet which does not pose a snagging hazard to persons handling it. The hook comprises a shank portion, at least one bent return portion, and a barb at the upper end of the return portion. The return portion of the hook has a longitudinal axis which is generally parallel to the longitudinal axis of the shank. The barb terminates in a sharply pointed free end contiguous with a generally semi-tear-drop shaped, relatively blunt, edge surface. That edge surface includes a curved portion spaced laterally of the longitudinal axis of the return portion of the hook and a contiguous undercut portion merging with the return portion of the hook. The curved portion of the edge surface may be directed toward or away from the shank of the hook. However, the Levin '660 patent does not have a slidable weight and a slidable treble hook both having movement stops.

While the above-described devices fulfill their respective, particular objectives and requirements, the aforementioned patents do not describe a bottom fish rig that allows fishing tackle having a slidable weight with a sliding three pronged hook. The Hnizdor '852, Petrasek '947, Carlson '178, Lewis '910, Snyder '508 and Levin '660 patents make no provision for a slidable weight and a slidable treble hook both having movement stops.

Therefore, a need exists for a new and improved bottom fish rig which can be used for fishing tackle having a slidable weight with a sliding three pronged hook. In this regard, the present embodiment of the invention substantially fulfills this need.

In this respect, the bottom fish rig according to the present embodiment of the invention substantially departs from the conventional concepts and designs of the prior art, and in doing so provides an apparatus primarily developed for the purpose of fishing tackle having a slidable weight with a sliding three pronged hook.

### SUMMARY OF THE INVENTION

In view of the foregoing disadvantages inherent in the known types of fishing tackle now present in the prior art, the present embodiment of the invention provides an improved bottom fish rig, and overcomes the above-mentioned disadvantages and drawbacks of the prior art. As such, the general purpose of the present embodiment of the invention, which will be described subsequently in greater detail, is to provide a new and improved bottom fish rig and method which has all the advantages of the prior art mentioned heretofore and many novel features that result in a bottom fish rig which is not anticipated, rendered obvious, suggested, or even implied by the prior art, either alone or in any combination thereof.

To attain this, the present embodiment of the invention essentially comprises an elongated leader having a hook end and a line end. The hook end having a hook eye loop and the line end having a line eye loop. A first movement stop is frictionally connected to the leader. A second movement stop is frictionally connected to the leader. The second movement stop is located between the first movement stop and the leader hook end. A c-weight is slidably connected to the leader. The c-weight has a first end having a first bore and a second end having a second bore.

There has thus been outlined, rather broadly, the more important features of the embodiment of the invention in order that the detailed description thereof that follows may be better understood and in order that the present contribution to the art may be better appreciated.

The present embodiment of the invention may also include a treble hook, a snap and a swivel. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

It is therefore an object of the present embodiment of the invention to provide a new and improved bottom fish rig that has all of the advantages of the prior art fishing tackle and none of the disadvantages.

It is another object of the present embodiment of the invention to provide a new and improved bottom fish rig that may be easily and efficiently manufactured and marketed.

An even further object of the present embodiment of the invention is to provide a new and improved bottom fish rig that has a low cost of manufacture with regard to both materials and labor, and which accordingly is then susceptible of low prices of sale to the consuming public, thereby making such bottom fish rig economically available to the buying public.

Still another object of the present embodiment of the invention is to provide a new bottom fish rig that provides in the apparatuses and methods of the prior art some of the advantages thereof, while simultaneously overcoming some of the disadvantages normally associated therewith.

Even still another object of the present embodiment of the invention is to provide a bottom fish rig for fishing tackle having a slidable weight with movement stops.

Lastly, it is an object of the present embodiment of the invention is to provide a bottom fish rig for fishing tackle having a sliding three pronged hook with movement stops.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The embodiment of the invention will be better understood and objects other than those set forth above will become apparent when consideration is given to the following detailed description thereof. Such description makes reference to the annexed drawings wherein:

FIG. 1 is a top perspective view of the preferred embodiment of the bottom fish rig constructed in accordance with the principles of the present invention.

FIG. 2 is a first end view of the c-weight of the bottom fish rig of the present embodiment of the invention.

FIG. 3 is a left side view of the c-weight of the bottom fish rig of the present embodiment of the invention.

FIG. 4 is a second end view of the c-weight of the bottom fish rig of the present embodiment of the invention.

FIG. 5 is a top perspective view of the treble hook of the bottom fish rig of the present embodiment of the invention.

FIG. 6 is a top perspective view of a second embodiment of the bottom fish rig of the present embodiment of the invention.

The same reference numerals refer to the same parts throughout the various figures.

### DESCRIPTION OF THE PREFERRED EMBODIMENT

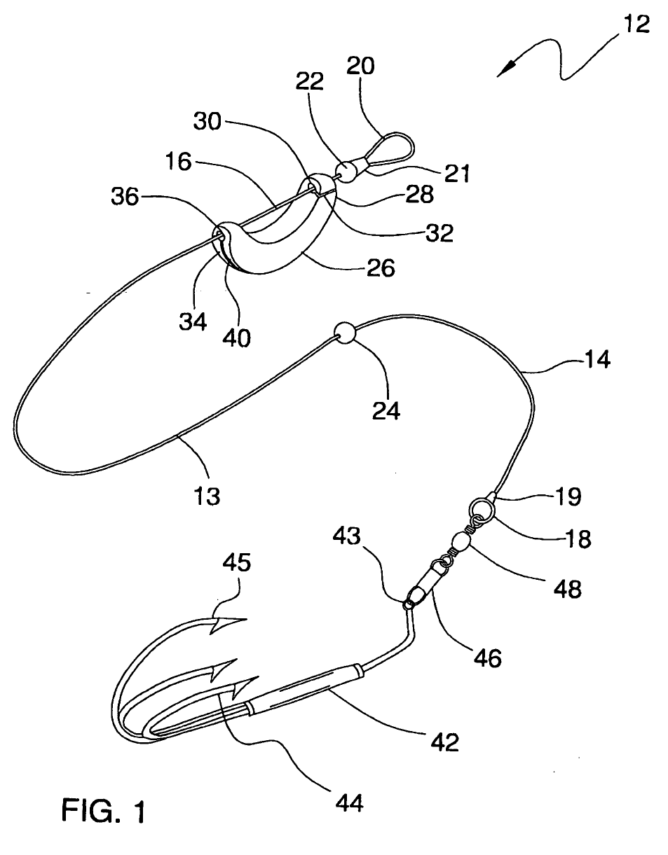

Referring now to the drawings, and particularly to FIGS. 1-5, a preferred embodiment of the bottom fish rig of the present invention is shown and generally designated by the reference numeral 10.

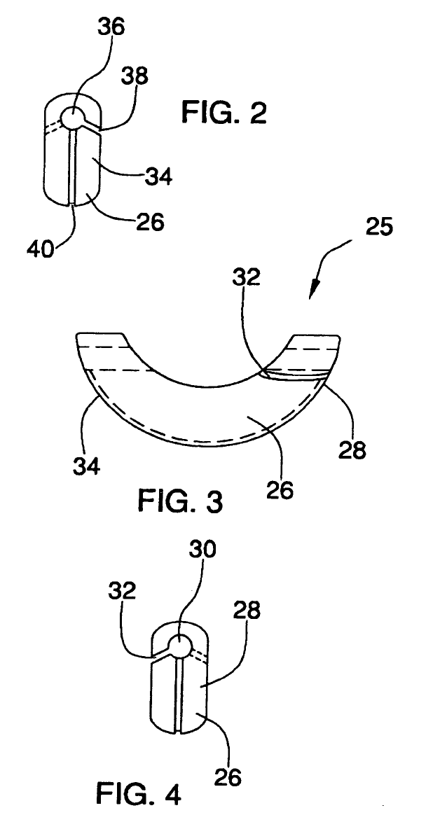

In FIG. 1, a new and improved bottom fish rig 10 of the present invention for fishing tackle having a slidable weight with a sliding three pronged hook is illustrated and will be described. More particularly, the bottom fish rig 10 has an elongated leader 12 that has two opposite ends, a hook end 14 and a line end 16. The hook end 14 has a hook eye loop 18 therein. The line end 16 has a line eye loop 20 therein. The leader 12 is approximately ten inches long. A first movement stop 22 is frictionally connected to the leader 12 adjacent the line end 16. The first movement stop 22 is comprised of split shot. The first movement stop 22 is located approximately two inches from the leader line end 16. A second movement stop 24 is frictionally connected to the leader 12. The second movement stop 24 is located between the first movement stop 22 and the leader hook end 14. The second movement stop 24 is comprised of split shot. The second movement stop 24 is located approximately three inches from the leader hook end 14. A c-weight 26 is slidably connected to the leader 12. The c-weight 26 has substantially the c-shape. The c-weight 26 has a first end 28. The first end 28 has a first bore therethrough 30. The c-weight 26 has a second end 34. The second end 34 has a second bore therethrough 36. The c-weight 26 has a first slot 32 connected to the first bore 30. The c-weight 26 has a second slot 38 (shown in FIG. 2) connected to the second bore 36. The c-weight 26 has a groove 40 therein for allowing the c-weight to be fixedly is connected to the leader 12. A treble hook 42 is slidably connected to the leader 12. The treble hook 42 is located between the second movement stop 24 and the hook eye loop 18. The treble hook 42 has a set of three barbs 44 which are disposed within the 180 degree section, this placement of the barbs 44 allows the treble hook 42 to slide upon the lake bottom without being caught on debris. A swivel 48 is connected to the hook eye loop 18. A snap 46 is connected to the swivel 48.

In FIG. 2, the bottom fish rig 10 is illustrated and will be described. The c-weight 26 is slidably connected to the leader 12 (shown in FIG. 1). The c-weight 26 has substantially the c-shape. The c-weight 26 has the second end 34. The second end 34 has the second bore therethrough 36. The c-weight 26 has the second slot 38 connected to the second bore 36. The c-weight 26 has the groove 40 therein for allowing the c-weight to be fixedly is connected to the leader 12.

In FIG. 3, the bottom fish rig 10 is illustrated and will be described. The c-weight 26 is slidably connected to the leader 12 (shown in FIG. 1). The c-weight 26 has substantially the c-shape. The c-weight 26 has the first end 28. The c-weight 26 has the second end 34. The c-weight 26 has the first slot 32 connected to the first bore 30 (shown in FIG. 4).

In FIG. 4, the bottom fish rig 10 is illustrated and will be described. The c-weight 26 is slidably connected to the leader 12. The c-weight 26 has substantially the c-shape. The c-weight 26 has the first end 28. The first end 28 has the first bore therethrough 30. The c-weight 26 has the first slot 32 connected to the first bore 30.

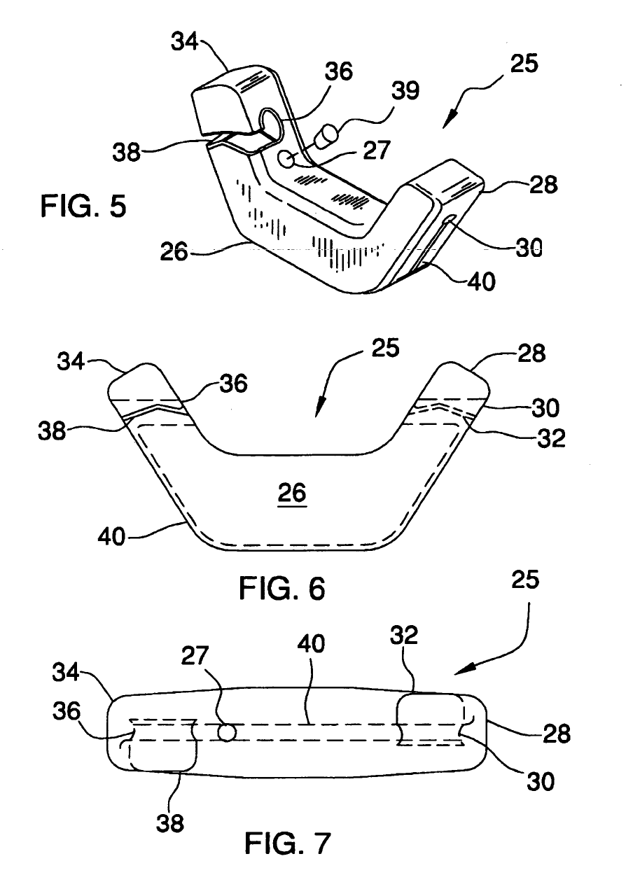

In FIG. 5, the bottom fish rig 10 is illustrated and will be described. The treble hook 42 is slidably connected to the leader 12. The treble hook 42 has three barbs 44 which are disposed within the 180 degree section, this placement of the barbs 44 allows the treble hook 42 to slide upon the lake bottom without being caught on debris.

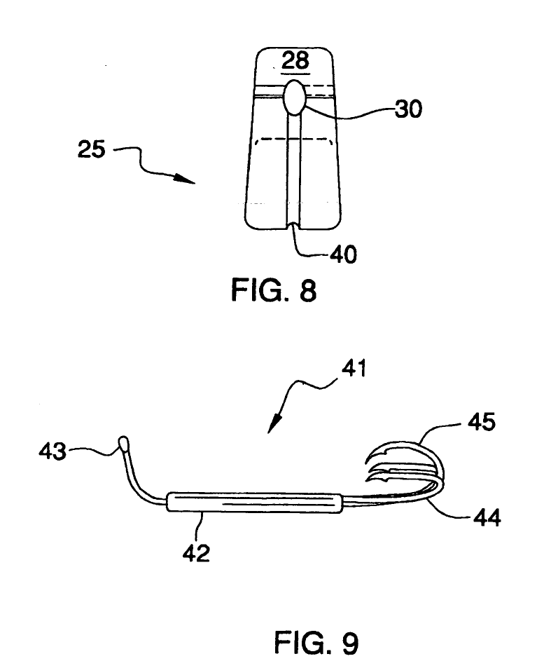

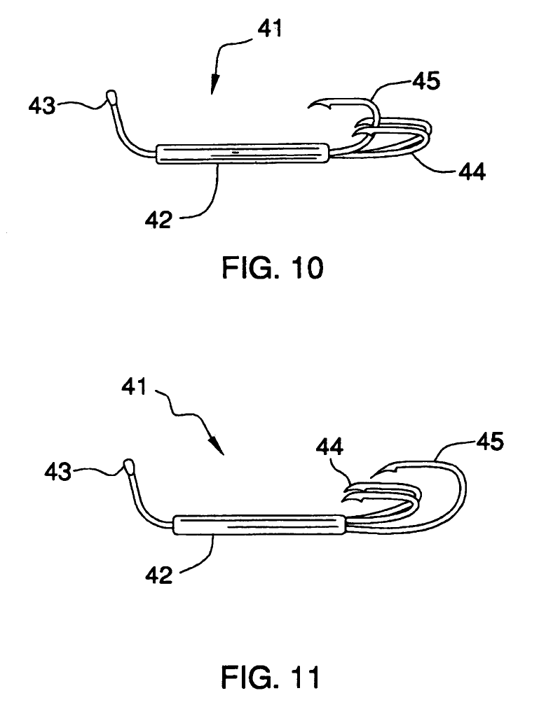

In FIG. 6, the bottom fish rig 10 is illustrated and will be described. More particularly, the bottom fish rig 10 has the elongated leader 12 that has two opposite ends, the hook end 14 and the line end 16. The hook end 14 has the hook eye loop 18 therein. The line end 16 has the line eye loop 20 therein. The leader 12 is approximately ten inches long. The first movement stop 22 is frictionally connected to the leader 12 adjacent the line end 16. The first movement stop 22 is comprised of split shot. The first movement stop 22 is located approximately two inches from the leader line end 16. The second movement stop 24 is frictionally connected to the leader 12. The second movement stop 24 is located between the first movement stop 22 and the leader hook end 14. The second movement stop 24 is comprised of split shot. The second movement stop 24 is located approximately three inches from the leader hook end 14. The c-weight 26 is slidably connected to the leader 12. The c-weight 26 has substantially the c-shape. The c-weight 26 has the first end 28. The first end 28 has the first bore therethrough 30. The c-weight 26 has the second end 34. The second end 34 has the second bore therethrough 36. The c-weight 26 has the first slot 32 connected to the first bore 30. The c-weight 26 has the second slot 38 (shown in FIG. 2) connected to the second bore 36. The c-weight 26 has the groove 40 therein for allowing the c-weight to be fixedly is connected to the leader 12. The swivel 48 is connected to the hook eye loop 18. The snap 46 is connected to the swivel 48. The treble hook 42 is connected to the snap 46. The treble hook 42 has three barbs 44 which are disposed within the 180 degree section, this placement of the barbs 44 allows the treble hook 42 to slide upon the lake bottom without being caught on debris.

While a preferred embodiment of the bottom fish rig has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention. For example, any suitable sturdy material such aluminum may be used instead of the lead c-weight described. Also, the treble hook may also be made of stainless steel. Furthermore, a wide variety of hook sizes, different colored jigs and darts may be used instead of the one described.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

1. A bottom fish rig comprising:
an elongated leader having two opposite ends, a hook end and a line end, said hook end having an hook eye loop therein, said line end having a line eye loop therein;
a first movement stop frictionally connected to said leader adjacent said line end;
a second movement stop frictionally connected to said leader, said second movement stop located between said first movement stop and said leader hook end; and
a c-weight slidably connected to said leader, said c-weight having a substantially c-shape, said c-weight having a first end, said first end having a first bore therethrough, said c-weight having a second end, said second end having a second bore therethrough.

2. The bottom fish rig of claim 1 wherein:
said c-weight having a first slot connected to said first bore; and
said c-weight having a second slot connected to said second bore.

3. The bottom fish rig of claim 1 wherein:
said c-weight having a groove therein for allowing the c-weight to be fixedly connected to said leader.

4. The bottom fish rig of claim 1 further comprising:
a treble hook slidably connected to said leader, said treble hook located between said second movement stop and said hook eye loop.

5. The bottom fish rig of claim 4 wherein:
said treble hook has three barbs which are disposed within a 180 degree section, this placement of the barbs allows the treble hook to slide upon the lake bottom without being caught on debris.

6. The bottom fish rig of claim 1 further comprising:
a swivel connected to said leader hook eye loop.

7. The bottom fish rig of claim 1 further comprising:
a snap connected to said swivel.

8. The bottom fish rig of claim 7 further comprising:
a treble hook connected to said snap.

9. The bottom fish rig of claim 1 wherein:
said first movement stop is comprised of split shot; and
said second movement stop is comprised of split shot.

10. The bottom fish rig of claim 1 wherein:
said leader is approximately ten inches long.

11. The bottom fish rig of claim 1 wherein:
said first movement stop is located approximately two inches from said leader line end.

12. The bottom fish rig of claim 1 wherein:
said second movement stop is located approximately three inches from said leader hook end.

13. A bottom fish rig comprising:
an elongated leader having two opposite ends, a hook end and a line end, said hook end having an hook eye loop therein, said line end having a line eye loop therein;
a first movement stop frictionally connected to said leader adjacent said line end;
a second movement stop frictionally connected to said leader, said second movement stop located between said first movement stop and said leader hook end; and
a c-weight slidably connected to said leader, said c-weight having a substantially c-shape, said c-weight having a first end, said first end having a first bore therethrough, said c-weight having a second end, said second end having a second bore therethrough, said c-weight having a first slot connected to said first bore, said c-weight having a second slot connected to said second bore, said c-weight having a groove therein for allowing the c-weight to be fixedly connected to said leader.

14. The bottom fish rig of claim 13 further comprising:
a treble hook slidably connected to said leader, said treble hook located between said second movement stop and said hook eye loop, said treble hook has three barbs which are disposed within a 180 degree section, this placement of the barbs allows the treble hook to slide upon the lake bottom without being caught on debris.

15. The bottom fish rig of claim 14 further comprising:
a swivel connected to said leader hook eye loop.

16. The bottom fish rig of claim 15 further comprising:
a snap connected to said swivel.

17. The bottom fish rig of claim 16 further comprising:
a treble hook connected to said snap.

18. The bottom fish rig of claim 17 wherein:
said first movement stop is comprised of split shot; and
said second movement stop is comprised of split shot.

19. The bottom fish rig of claim 18 wherein:
said leader is approximately ten inches long;
said first movement stop is located approximately two inches from said leader line end; and
said second movement stop is located approximately three inches from said leader hook end.

20. A bottom fish rig comprising:
an elongated leader having two opposite ends, a hook end and a line end, said hook end having an hook eye loop therein, said line end having a line eye loop therein, said leader is approximately ten inches long;
a first movement stop frictionally connected to said leader adjacent said line end, said first movement stop is comprised of split shot, said first movement stop is located approximately two inches from said leader line end;
a second movement stop frictionally connected to said leader, said second movement stop located between said first movement stop and said leader hook end, said second movement stop is comprised of split shot, said second movement stop is located approximately three inches from said leader hook end;
a c-weight slidably connected to said leader, said c-weight having a substantially c-shape, said c-weight having a first end, said first end having a first bore therethrough, said c-weight having a second end, said second end having a second bore therethrough, said c-weight having a first slot connected to said first bore, said c-weight having a second slot connected to said second bore, said c-weight having a groove therein for allowing the c-weight to be fixedly connected to said leader;
a treble hook slidably connected to said leader, said treble hook located between said second movement stop and said hook eye loop, said treble hook has three barbs which are disposed within a 180 degree section, this placement of the barbs allows the treble hook to slide upon the lake bottom without being caught on debris;
a swivel connected to said leader hook eye loop; and
a snap connected to said swivel.
